(19) United States
(12) Patent Application Publication
(10) Pub. No.: US 2011/0035767 A1
(43) Pub. Date: Feb. 10, 2011

(54) IPTV REMOTE BROADCASTING SYSTEM FOR AUDIENCE PARTICIPATION AND SERVICE PROVIDING METHOD THEREOF

(75) Inventors: Jun Sup Lee, Daejeon (KR); Jun Suk Lee, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/792,049

(22) Filed: Jun. 2, 2010

(30) Foreign Application Priority Data
Aug. 10, 2009 (KR) 10-2009-0073348

(51) Int. Cl. H04N 7/173

(52) U.S. Cl. 725/24

(57) ABSTRACT

Provided are an IPTV remote participation broadcasting system for audience participation and a service providing method thereof. The IPTV remote participation broadcasting system includes an IPTV participation support system and an IPTV head end system. The IPTV participation support system obtains an object picture of a broadcasting master and object pictures of a plurality of participation applicants, and combines the obtained object pictures in a content screen of a virtual environment to generate a real-time participation broadcasting picture in which the participation applicants participate directly. The IPTV head end system receives the real-time participation broadcasting picture to transmit live the real-time participation broadcasting picture, in which the broadcasting master and the participation applicants interact in the content screen of the virtual environment, to user terminals of the participation applicants over an IP communication network.

### CROSS-REFERENCE TO RELATED APPLICATIONS

This application claims priority under 35 U.S.C. §119 to Korean Patent Application No. 10-2009-0073348, filed on Aug. 10, 2009, in the Korean Intellectual Property Office, the disclosure of which is incorporated herein by reference in its entirety.

### TECHNICAL FIELD

The following disclosure relates to an Internet Protocol Television (IPTV) remote broadcasting system for audience participation and a service providing method thereof.

### BACKGROUND

IPTV is an interactive television service that is provided over a high-speed Internet network. The IPTV has no large difference with respect to cable broadcasting or satellite broadcasting in that it provides broadcasting content including video. However, the IPTV has a large difference with respect to cable broadcasting or satellite broadcasting in that it provides an interactive broadcasting service.

However, an interactive broadcasting service that is provided through the existing IPTV may be an unstable interactive broadcasting service in that a user selects a broadcasting program to view the selected broadcasting program in a desired time and participates only in control for picture replay.

In broadcasting content that is provided through IPTV, particularly, because broadcasting content such as the existing educational broadcasting or online lectures is recorded in advance and the recorded broadcasting content is one-sidely provided to audiences in a streaming scheme, the degrees of participation and absorption of students like actual school are degraded.

A level, in which audiences directly participate in broadcasting based on a current IPTV, is merely a level in which the audiences sends a Short Message Service (SMS) message to an IPTV server to display characters on a portion of a screen that is being broadcasted, or an announcer reads out content. Alternatively, in a case of providing a quiz type of broadcasting service based on IPTV, audiences may participate in broadcasting through a very fragmentary participation scheme such as a participation scheme in which a user clicks buttons and sends information on the clicked buttons to a server, thereby participating in a quiz.

For the education of foreign languages, recently, private education providers provide remote video education using long-distance natives or electronic learning (e-Learning) that performs learning in a virtual learning space based on the Internet. Although such video education increases the degrees of absorption and participation of users, because the video education is made in a one-to-one correspondence scheme or through small groups, the users consume very much cost for receiving a broadcasting service for the video education and the number of users capable of receiving the broadcasting service is limited.

### SUMMARY

In one general aspect, an IPTV remote participation broadcasting system for audience participation includes: an IPTV participation support system obtaining an object picture of a broadcasting master and object pictures of a plurality of participation applicants, and combining the obtained object pictures in a content screen of a virtual environment to generate a real-time participation broadcasting picture in which the participation applicants participate directly; and an IPTV head end system receiving the real-time participation broadcasting picture to transmit the real-time participation broadcasting picture, in which the broadcasting master and the participation applicants interact in the content screen of the virtual environment, to user terminals of the participation applicants over an IP communication network.

In another general aspect, a method for providing IPTV remote participation broadcasting service for audience participation includes: obtaining, by an IPTV participation support system, an object picture of a broadcasting master and object pictures of a plurality of participation applicants; combining, by an IPTV participation support system, the obtained object pictures in a content screen of a predetermined virtual environment to generate a real-time participation broadcasting picture in which the participation applicants participate directly; and transmitting live, by an IPTV head end system, the real-time participation broadcasting picture to user terminals of a plurality of IPTV audiences which include the participation applicants over an IP communication network.

In another general aspect, a method for providing IPTV remote participation broadcasting service for audience participation includes: accessing, by a plurality of IPTV terminals, an IPTV participation education channel through an IPTV head end system; registering, by the IPTV terminals, corresponding IPTV service users as participants of a participation broadcasting channel; selecting, by an IPTV participation support system, at least one participant which desires to appear in broadcasting from among the registered participants; combining, by the IPTV participation support system, the object picture of the broadcasting master and an object picture of the selected participant by using a content screen of a predetermined virtual environment as a background through a picture combination module to generate a real-time participation broadcasting picture; and transmitting the real-time participation broadcasting picture to IPTV terminals of the participants through the IPTV head end system.

Other features and aspects will be apparent from the following detailed description, the drawings, and the claims.

### BRIEF DESCRIPTION OF THE DRAWINGS

FIG. 1 is a diagram for describing the basic concept of an IPTV remote broadcasting system for audience participation according to an exemplary embodiment.

FIG. 2 is a diagram illustrating an operation of creating a real-time broadcasting screen which is finally created through the IPTV remote participation broadcasting system in FIG. 1.

FIG. 3 is a diagram illustrating a system configuration for implementing the IPTV remote participation broadcasting system according to an exemplary embodiment in FIG. 1.

FIG. 4 is a block diagram illustrating an example of the internal configuration of an IPTV participation support system in FIG. 3.

FIG. 5 is a flow chart illustrating the operation of the IPTV remote participation broadcasting system in FIG. 3.

FIG. 6 is a flow chart illustrating a method for providing IPTV remote participation broadcasting service for audience participation according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

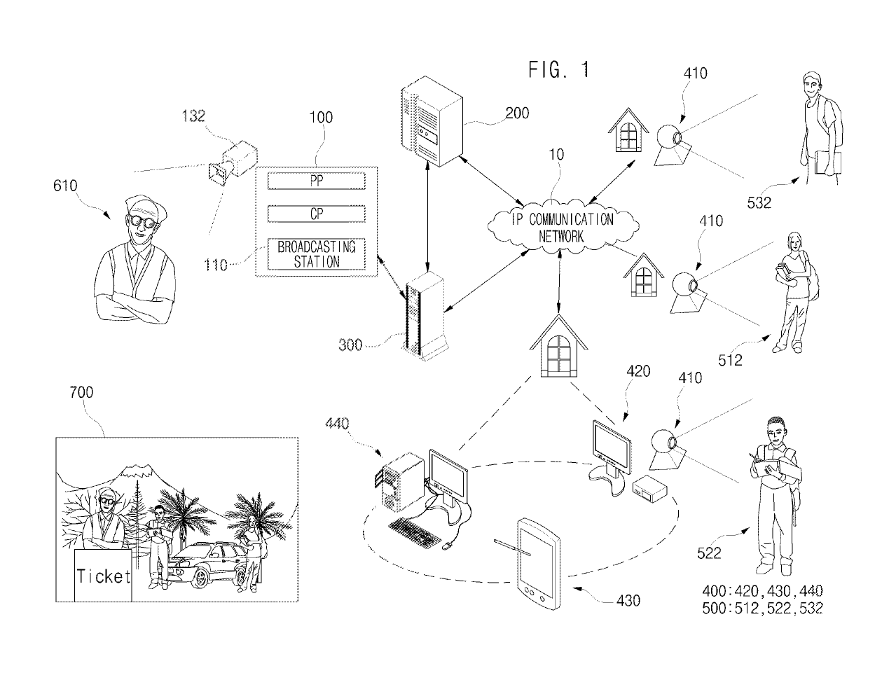

FIG. 1 is a diagram for describing the basic concept of an IPTV remote broadcasting system for audience participation according to an exemplary embodiment. In this embodiment, an IPTV remote participation broadcasting system that provides real-time participation content will be described below as an example.

Referring to FIG. 1, in the IPTV remote broadcasting system for audience participation (hereinafter referred to as an IPTV remote participation broadcasting system), IPTV service users 500 include participation audiences 512 and 522 (hereinafter referred to as a participation applicant) that apply the appearance of broadcasting for directly appearing in broadcasting as cast members, and a non-participation audience 532 that does not appear in broadcasting.

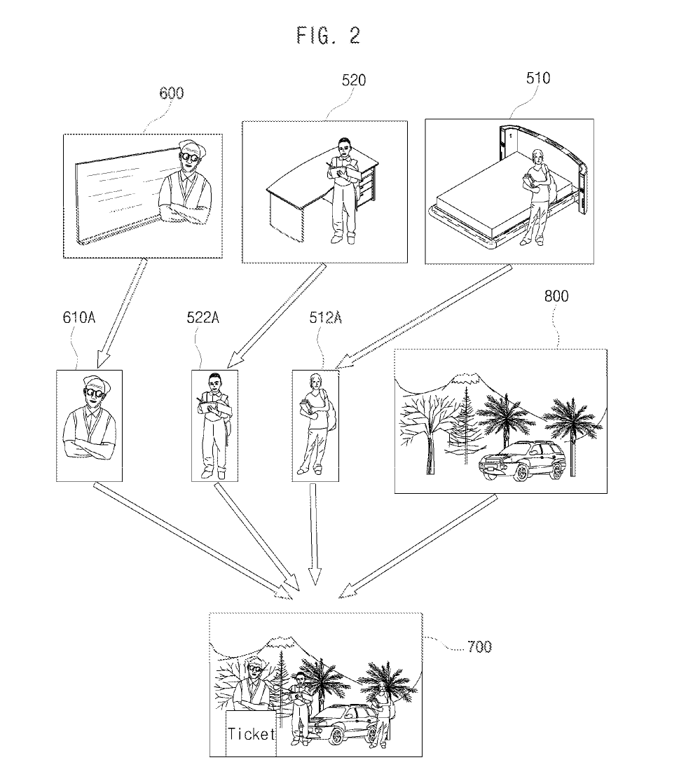

The participation applicants 512 and 522 are combined on a screen in which a broadcasting master 610 and a virtual environment are combined. Accordingly, the participation applicants 512 and 522, the screen of a virtual environment 800 (see FIG. 2) and the broadcasting master 610 are combined and thereby a real-time broadcasting screen 700 is finally created.

Subsequently, the real-time participation broadcasting between the broadcasting master 610 and the participation applicants 512 and 522 that exist in the real-time broadcasting screen 700 is made.

The real-time broadcasting screen 700 is transmitted as a real-time participation broadcasting picture (hereinafter referred to as a broadcasting picture) to the audience 532 that does not appear in broadcasting over an IP communication network 10 and the participation applicants 512 and 522 that appear in broadcasting over the IP communication network 10.

For the appearance of broadcasting, video equipment (which acquires the pictures of the participation applicants 512 and 522 and includes an IPTV terminal 400, which includes a set-top box 420, a portable terminal 430 and a personal computer (PC) 440, and a web cam 410 or a camcorder (not shown)) is basically included in the each home of the participation applicants 512 and 522 among the IPTV service users 512, 522 and 532.

A content providing system 100 provides content that includes a screen including the combined broadcasting master 610 and the content of the virtual environment (see FIG. 2).

The three kinds of participation audiences 512 and 522, broadcasting master 610 and content of the virtual environment are combined in real time, and the screen of the combined result is created as the real-time broadcasting screen 700. The real-time broadcasting screen 700 is broadcasted to all the IPTV service users 512, 522 and 532 over the IP communication network 10.

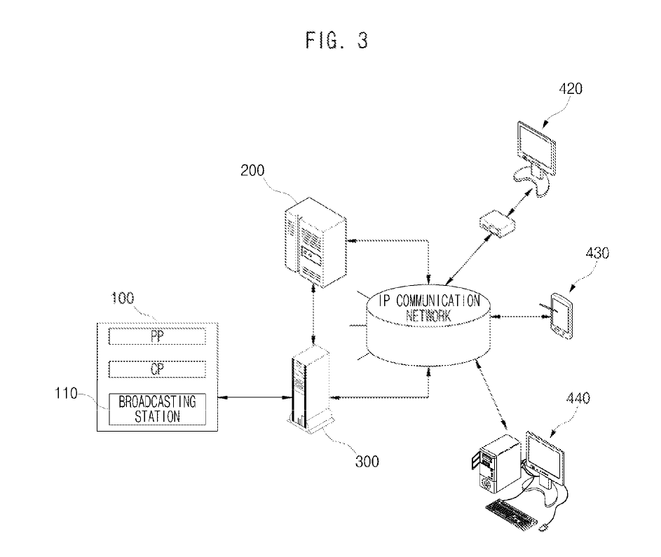

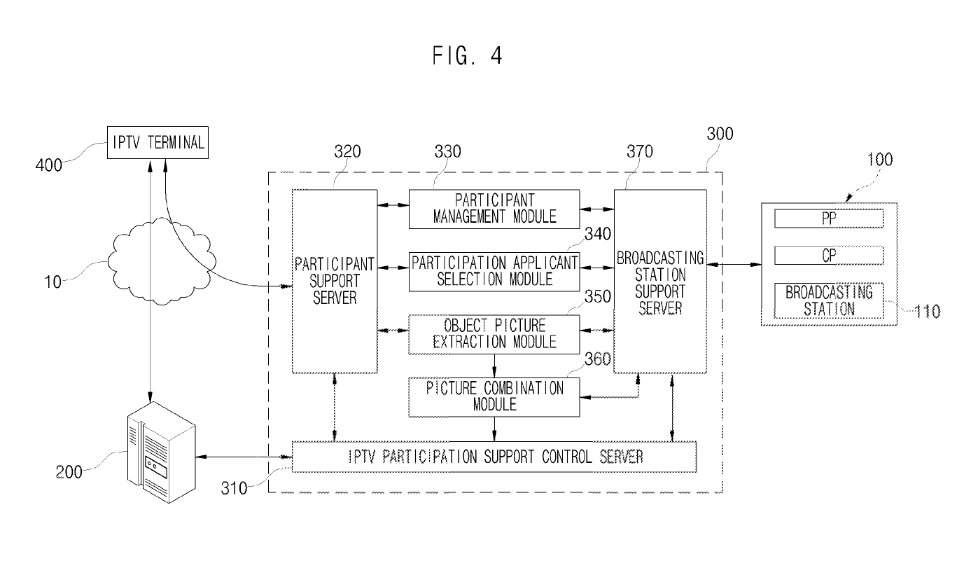

An IPTV head end system 200 (see FIG. 1) and an IPTV participation support system 300 will be described below in detail with reference to FIGS. 3 and 4.

FIG. 2 is a diagram illustrating an operation of creating a real-time broadcasting screen which is finally created through the IPTV remote participation broadcasting system in FIG. 1.

Referring to FIGS. 1 and 2, the entire pictures 510 and 520 of the participation applicants 512 and 522 among the IPTV service users 512, 522 and 532 are acquired through the web cam 410 that basically includes a voice collector such as a microphone.

In the entire picture 510, subsequently, the participation applicant 512 is extracted from a background as an object 512A in real time. In the entire picture 520, the participation applicant 522 is extracted from a background as an object 522A in real time. At this point, in the broadcasting station of the content providing system 100, the entire picture of the broadcasting master 610 is acquired through a broadcasting camera 132 that is disposed in the studio of the broadcasting station. In the acquired entire picture 600, the broadcasting master 610 is extracted from a background as an object 610A in real time.

The objects 512A, 522A and 610A which are respectively extracted from the entire pictures 510, 520 and 600, i.e., the broadcasting master 610 and the participation applicants 512 and 522 are combined with the content screen of a virtual environment 800 that is provided from the content providing system 100. That is, the participation applicants 512 and 522 and the broadcasting master 610 are displayed on one broadcasting screen by using the content screen of the virtual environment 800 as a background.

In the broadcasting screen 700 that is combined in this way, the participation applicants 512 and 522 and the broadcasting master 610 converse in real time on the content screen of the virtual environment 800 and communicate through gestures while looking at each other, and thus the learning environment of a remote virtual space is formed.

The combined broadcasting screen 700 is transmitted in real time to the IPTV service users 512, 522 and 532 in respective homes over the IP communication network 10. A terminal for receiving the broadcasting screen 700 includes a set-top box, the portable terminal 430 based on IPTV, and the PC 440. At this point, an IPTV service user that does not have the video equipment such as the web cam 410 or the camcorder (not shown), for example, the audience 532 (see FIG. 1) cannot participate in broadcasting and may merely view the broadcasting.

In this embodiment, the content screen of the virtual environment 800 may be set to have various backgrounds such as foreign airports and banks. In the set background, real-time interaction broadcasting between the broadcasting master 610 and the participation applicants 512 and 522 that participate in broadcasting in real time may be made.

In remote participation broadcasting content according to an exemplary embodiment, moreover, the participation applicant 512 which participates in broadcasting may perform interaction between it and the broadcasting master 610 and interaction between it and the participation applicant 522, for example, conversation, gestures and the touch of content of a virtual environment. Therefore, the IPTV remote participation broadcasting system according to an exemplary embodiment improves the degrees of absorption and participation of the participation applicants 512 and 522 for broadcasting, providing an efficient direct experience.

In this embodiment, unlike the existing online lecture incapable of the direct participation of students, students that reside in different areas may directly appear in broadcasting as the participation applicants 512 and 514 to solve various quizzes and feed back a result of the solution. Accordingly, students using the IPTV remote participation broadcasting system according to an exemplary embodiment may receive good quality education even without directly going private institutes.

According to the IPTV remote participation broadcasting system according to an exemplary embodiment, the participation applicants 512 and 522 that reside in different areas appear directly in broadcasting and express their thoughts and ideas on a combined broadcasting screen through interaction such as voice and gestures, and thus vivid visual content for conference can be provided.

The following description will be made in detail on a specific system configuration for implementing the IPTV remote participation broadcasting system according to an exemplary embodiment in FIG. 1.

FIG. 3 is a diagram illustrating, a system configuration for implementing the IPTV remote participation broadcasting system according to an exemplary embodiment in FIG. 1.

Referring to FIG. 3, an IPTV remote participation broadcasting system 300 according to an exemplary embodiment includes an IPTV head end system 200 and an IPTV participation support system 300. In detail, the IPTV remote participation broadcasting system 300 further includes a content providing system 100, an IP communication network 10, and an IPTV terminal 400.

The content providing system 100 includes a Program Provider (PP) that provides broadcasting programs for language education through real-time participation education channels, a Content Provider (CP) that provides remote participation broadcasting content including the content, of a virtual environment, and a broadcasting station 110 that provides the screen of the broadcasting master 610 that is combined with the content screen of the virtual environment 800 (see FIG. 2) corresponding to the content of the virtual environment.

The IPTV head end system 200 transmits a broadcasting picture for each broadcasting channel to the user terminal 400 of each home. As described above, the IPTV head end system 200 provides the broadcasting picture, in which interaction (for example, conversation, gesture and touch events in a virtual environment) between a broadcasting master and participation applicants may be made, as a broadcasting picture in which the broadcasting master and the participation applicants are combined by using a virtual environment provided from the content providing system 100 as a background. Moreover, the IPTV head, end system 200 multiplexes the broadcasting picture, a voice, signal, data for data broadcasting and program-related information (for example, Program and Specific Information (PSI)) and transmits the multiplexed result together with Electric Program Guide (EPG) information to the user terminal 400 of each home in a multicast scheme. The IPTV head end system 200 includes all sorts of IPTV service systems that provide on-demand service.

Alternatively, the IPTV head end system 200 has a difference with respect to the existing IPTV system configuration in that it receives real-time participation content through the IPTV participation support system 300, unlike the existing IPTV head end system for directly receiving real-time participation content. Therefore, some functions that are performed in the existing IPTV head end system 200 may be performed in the IPTV participation support system 300, according to a direct connection scheme between the IPTV head end system 200 and the content providing system 100.

The IPTV participation support system 300 selects IPTV users desiring the appearance of broadcasting for allowing each IPTV user to appear in a broadcasting picture for language education that uses a virtual environment provided in real time from the content providing system 100 as a background, and allows the selected IPTV users to directly appear in the language education broadcasting. A detailed description on this will be made below with reference to FIG. 4.

The IPTV terminal 400 includes an IPTV using the set-top box 420, a portable terminal 430 and a PC 440. The IPTV terminal 400 receives remote participation broadcasting content that is transmitted from the IPTV head end system 200, i.e., a real-time broadcasting picture in which the participation applicant 512 participates directly, over the IP communication network 10.

Hereinafter, the IPTV participation support system 300 will be described in detail.

FIG. 4 is a block diagram illustrating an example of the internal configuration of the IPTV participation support system in FIG. 3.

Referring to FIG. 4; the IPTV participation support system 300 serves as the agent of the content providing system 100. As the agent of the content providing system 100, that is, the IPTV participation support system 300 transmits remote participation broadcasting content provided from the content providing system 100 to each IPTV audience through the IPTV head end system 200.

The IPTV participation support system 300 may alone serve as the agents of a plurality of content providing systems, according to the scale of the content providing system 100 and a content providing type. Alternatively, as illustrated in FIG. 4, one IPTV participation support system 300 may serve as the agent of one content providing system 100, according to the scale of the content providing system 100 and a content providing type. Thus, when the content providing system 100 is in plurality, a plurality of IPTV participation support systems 300 may serve as the agents of a plurality of content providing systems, respectively.

The IPTV participation support system 300 includes an IPTV participation support control server 310, a participant support server 320, a participant management module 330, a participation applicant selection module 340, an object picture extraction module 350, and a picture combination module 360.

The IPTV participation support control server 310 is connected to the IPTV head end system 200, transmits a real-time participation content broadcasting picture according to an exemplary embodiment to the IPTV head end system 200, and supports the transmission of the real-time participation content broadcasting picture. Moreover, the IPTV participation support control server 310 transmits guide information for the broadcasting participation service of IPTV audiences to a corresponding IPTV terminal through the IPTV head end system 200. The IPTV participation support control server 310 is connected to the other modules that configures the IPTV participation support system 300, and manages and controls the modules.

As a web service server that the IPTV service user 500 accesses, the participant support server 320 performs all sorts of processing operations that include an operation of processing the access request message of an IPTV service user and an operation of authenticating an IPTV service user that requests access. When the IPTV service subscription of the IPTV service user that requests access is checked, a broadcasting picture according to an exemplary embodiment is transmitted to the terminal of a corresponding IPTV service user (hereinafter referred to as an IPTV audience). Such an operation of processing the access request of the IPTV user is performed in the existing IPTV head end system. In this embodiment, however, the operation of processing the access request of the IPTV user is performed in the IPTV participation support system 300 including the participant support server 320. Moreover, the participant support server 320 performs all sorts of processing operations for the participation application of users which desire to directly participate in a broadcasting picture as actors, among IPTV audiences in which IPTV service subscription is checked.

The participant management module 330 manages in real time information for IPTV audiences that access the IPTV remote participation broadcasting system 300 according to an exemplary embodiment, and shares managed information with the other modules. When the content providing system 100 service a plurality of channels at the same time, the participant management module 330 establishes a database in which a content provider and channel information are simultaneously mapped for all IPTV service users that request access, and maintains and manages the database.

The participation applicant selection module 340 generates the list information of participation applicants among IPTV audiences that request participation in each participation broadcasting channel, and transmits the generated list information to the content providing system 100 through a broadcasting station support server 370. At this point, the participation applicant selection module 340 transmits the list information and the entire picture of a participation applicant that is acquired from the terminal 400 of the participation applicant over the IP communication network 10, to the content providing system 100. Moreover, the participation applicant selection module 340 receives the entire picture of a broadcasting master from the broadcasting station 110 and transmits the received picture to the object picture extraction module 350.

The content providing system 100, for example, selects IPTV service users, which intend to participate in a language learning content picture in real time, on the basis of the list information and the picture by a broadcasting master and a broadcasting producer. In the selection operation, the participation applicant selection modules 340 selects pictures in which an object is easily extracted from the picture of the participation applicant, for example, clear pictures in which the shape of a participation applicant in a picture is apparently shown. That is, the participation applicant selection module 340 selects the participation applicants of the IPTV terminals 400 that transmit high-quality pictures, and selects cast members from among the selected participation applicants at random.

The object picture extraction module 350 receives the entire picture of a broadcasting master from the broadcasting station and receives the entire pictures of participation applicants, which appear in broadcasting, over the IP communication network 10. The object picture extraction module 350 separates the objects 512A, 522A and 610A from the entire picture of the broadcasting master and the entire pictures of the participation applicants. Such a separation operation may be performed in a terminal according to the performance of the IPTV terminal 400. Accordingly, the object picture extraction module 350 may be included in the IPTV terminal 400.

The picture combination module 360 combines the pictures of the participation applicant and the broadcasting master and, which are separated in the object picture extraction module 350, in the predetermined position of the content of the predetermined virtual environment 800 (see FIG. 2) to create the real-time broadcasting screen 700 (see FIG. 2) that is live broadcasted. The picture combination module 360 collects the voice signals of the participation applicants over the IP communication networks 10 and changes the collected voice signals into one voice signal. By recognizing the object of the participation applicant, the picture combination module 360 recognizes the touch and/or gesture events of the participation applicants that occur in the virtual environment. When interaction between the participation applicants occurs according to a predetermined rule, a corresponding event is performed.

For generating a real-time broadcasting picture in which a participation applicant directly appears in broadcasting, the broadcasting station support server 370 supports the broadcasting station 110 in connection with the content providing system 100.

Specifically, the broadcasting station support server 370 provides the list information of the participation applicants and the pictures of the participation applicants to a content provider, thereby enabling the broadcasting station 110 to select actors for appearance. Moreover, the broadcasting station support server 370 performs various event services such as that a broadcasting master monitors participation users in real time or arbitrarily appoints participation applicants to question to the appointed applicant. For this, the broadcasting station support server 370 searches and appoints the participation applicants, and provides service related to other schools.

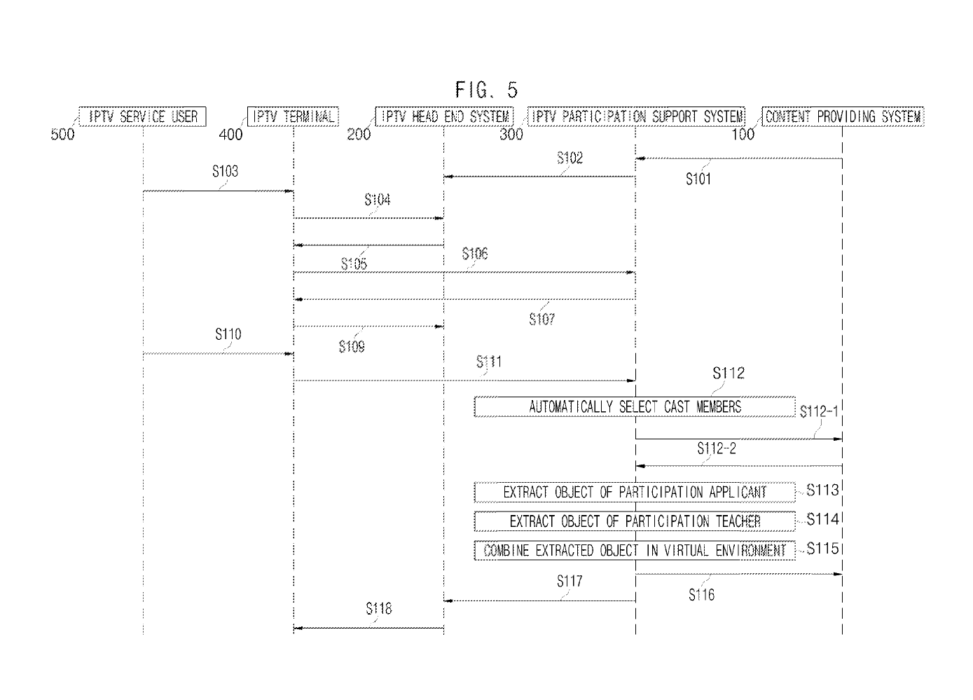

FIG. 5 is a flow chart illustrating the operation of the IPTV remote participation broadcasting system in FIG. 3.

Referring to FIGS. 3 and 5, the content of the virtual environment 800 (see FIG. 2) that is used as the background of a combined screen is set. Remote participation broadcasting content according to an exemplary embodiment is created beforehand by a content provider. Such an operation of creating the remote participation broadcasting content is largely divided into an operation that creates raw content including Three-Dimensional (3D) modeling, sound effect record, animation creation and image creation, and an operation that creates a content package for setting a rule which defines the positioning of the raw content and interaction between a broadcasting master and real-time remote broadcasting participants.

When the two operations are completed, remote participation broadcasting content for driving a system is created.

A broadcasting channel is established by a content provider, and initial intro broadcasting is provided to the IPTV participation support system 300 (hereinafter referred to as a participation support system) in operation S101.

Subsequently, the participation support system 300 registers the information of a corresponding channel in the IPTV head end system 200, and provides real-time remote participation broadcasting, which is provided from the content provider, to the IPTV head end system 200 in operation S102.

An IPTV broadcasting channel is selected by the IPTV service users 500 in respective homes.

The IPTV terminal 400 requests access to an IPTV remote participation broadcasting channel to the IPTV head end system 200 in operation S104. The IPTV head end system 200 presents its own access point to the IPTV terminal 400 and presents the server address of the participation support system of a corresponding channel by guiding the access point in operation S105.

The IPTV terminal 400 gets access to the server address of the participation support system 300 of a corresponding channel that receives the presentation from the IPTV head end system 200 and applies participant registration for registering as the participation applicant of a corresponding channel in operation S106.

The participation support system 300 that receives the registration application of participant checks the information of a participation applicant which is the owner of a corresponding IPTV terminal (for example, when pay service, a key is authenticated), and allows the access of a participation education channel in operation S107. At this point, the participation support system 300 lists the information of the participation applicant in a participant list.

The IPTV terminal 400 requests the IPTV broadcasting streaming of a corresponding channel to the IPTV head end system 200 in operation S108. At this point, the IPTV head end system 200 checks information for a user's request. That is, in the case of a pay channel, the IPTV head end system 200 checks whether an IPTV service user receives appropriate authentication for a corresponding pay channel from the participation support system 300.

When the authentication is checked as being received, a broadcasting picture is streamed in the IPTV terminal 400 in operation S109.

When the IPTV service user 500 applies broadcasting participation as an actor in operation S110, the IPTV terminal 400 is registered as a participation applicant in the participation support system 300 in operation S111.

When audience participation broadcasting is begun with broadcasting, a participation applicant to actually participate in live broadcasting is selected from among participation applicants. At this point, a broadcasting master or a broadcasting producer directly selects a cast member according to its own intent, or a cast member is automatically selected by the participation support system 300.

When the cast member is automatically selected, a participation applicant (which is the owner of the IPTV terminal 400 that transmits a clear voice signal and/or a clear picture from which an object is easily extracted) suitable for the appearance of broadcasting is selected from among participation applicants in the participation support system 300 in operation S112.

When the cast member is manually selected, the participation support system 300 provides the list information of cast members to the broadcasting master 600 or the broadcasting producer in operation S112-1. The broadcasting master 600 or the broadcasting producer manually checks a broadcasting applicant list, and selects participation applicants suitable for broadcasting from among the broadcasting applicant list in operation S112-2.

When the cast member is selected, a broadcasting master is extracted as an object from the entire picture of the broadcasting master in operation S113, and participation applicants are extracted as objects from the entire pictures of the participation applicants in operation S114. Operations S113 and S114, as described above, may be autonomously performed in an IPTV terminal according to the performance of the IPTV terminal 400, but in this embodiment, operations S113 and S114 are performed in the object picture extraction module 350 of the participation support system 300 in FIG. 4. Subsequently, the extracted objects are combined in a predetermined virtual environment in operation S115. The extracted object picture of the participation applicant and the extracted object picture of the broadcasting master are combined on the content screen of the virtual environment by the picture combination module 360 of the participation support system 300 in operation S115. Moreover, the voice signal of the participation applicant and the voice signal of the broadcasting master are combined. The combined voice signal is also combined with the virtual sound of virtual environment content and thereby the final combination sound is generated. Events such as conversation, gestures and touch, which occur in a picture where the extracted object picture of the participation applicant is combined in the content screen of the virtual environment, are checked, and the scenario of content that is defined based on a corresponding event is performed.

A real-time broadcasting screen that is created in this way is provided to the monitoring screen of a content provider in real time by the participation support system 300 in operation S116, is streamed to the IPTV head end system 200 in real time in operation S117 and thereby is streamed to all the terminals of the IPTV service users 500 that are viewing a corresponding broadcasting channel in operation S118.

Subsequently, a participation applicant, which participates in broadcasting as an actor, finally views in real time a broadcasting screen that it is directly participating or a broadcasting screen that another participation applicant is directly participating.

Before the end of broadcasting, the system of a broadcasting station may alternate in real time a participation applicant that appears in broadcasting and the configuration of content by a broadcasting master and a broadcasting producer, and another IPTV service user that does not appear in broadcasting may participate in broadcasting by applying participation when broadcasting is being performed.

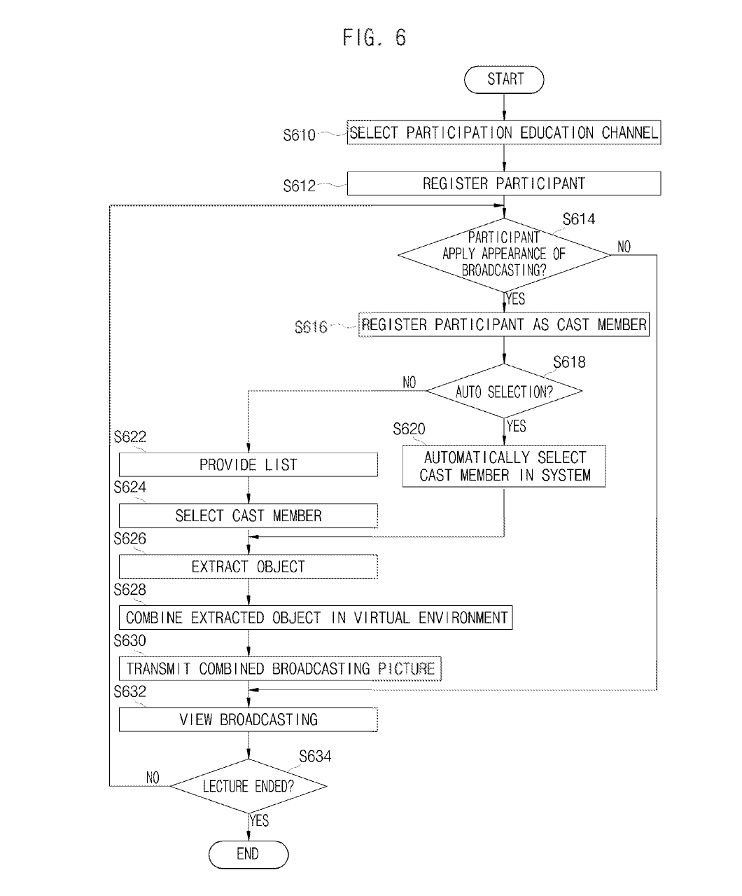

FIG. 6 is a flow chart illustrating a method for providing IPTV remote participation broadcasting service for audience participation according to an exemplary embodiment.

Referring to FIGS. 1 to 3 and 6, in a method for providing an IPTV remote broadcasting service for audience participation according to an exemplary embodiment, the IPTV service users 500 (i.e., service users) first select an IPTV participation education broadcasting channel through the IPTV terminal 400 of each of the IPTV service users 500 in operation S610. The IPTV terminal 400 requests the access of the IPTV participation education channel to the IPTV head end system 200. The IPTV head end system 200 presents its own access point to the IPTV terminal 400, and the server address of the IPTV participation support system 300 of a corresponding channel is presented to the IPTV terminal 400.

Subsequently, the IPTV terminal 400 applies applicant registration with the server address of the IPTV participation support system 300 of a corresponding channel, and the service user of the IPTV terminal 400 is registered as the participant of a participation education broadcasting channel in operation S612.

The participation support system 300 determines whether the registered participant applies the direct appearance of broadcasting as a cast member in operation S614.

When the participation support system 300 receives the application of participants that desire to appear in broadcasting as a cast member, through the IPTV terminal 400, and registers the participants as cast members in operation S616.

When a broadcasting event in which audiences directly participate in broadcasting is begun, participants that participate in live broadcasting are selected from among participants that are registered as cast members. At this point, a selection scheme for selecting participants that participate in broadcasting as cast members is determined in operation S618. As the selection scheme, there are an auto selection scheme in which the participation support system 300 automatically selects the applicants and a manual selection scheme in which the broadcasting master 600 or the broadcasting producer selects the applicants.

When the auto selection scheme in operation S618, the participants 512 and 522 suitable for the appearance of broadcasting are arbitrarily selected from among participation applicants in the participation support system 300 in operation S620. Herein, the suitable participant refers to an participant for a terminal that transmits clear voice information and clear picture information from which an object is easily extracted.

When the manual selection scheme in operation S618, the participation support system 300 provides a participant list to the broadcasting master 600 or the broadcasting producer in operation S622.

Subsequently, the broadcasting master 600 or the broadcasting producer manually checks a participation applicant list, and selects participants suitable for broadcasting from among the list as cast members in operation S624.

The object picture of a broadcasting teacher is extracted from an entire picture including the broadcasting master 600 and the object pictures of participants are extracted from entire pictures including the selected participants in operation S626.

The extracted object picture of each of the applicants 512 and 522 and the extracted object picture of the broadcasting master 600 are combined in the content of the virtual environment 800 by the picture combination module 305 of the participation support system 300 in operation S628.

Subsequently, a real-time broadcasting screen 700 that is finally combined is provided in real time as a monitoring screen to a content provider by the participation support system 300, and simultaneously is streamed to the IPTV head end system 200 in real time. Therefore, the real-time broadcasting screen 700 is streamed to all the terminals of the IPTV service users 500 that are viewing a corresponding broadcasting channel, by the IPTV head end system 200 in operation S630.

An IPTV service user views in real time the broadcasting screen of live broadcasting in which it is directly participating or a broadcasting screen of broadcasting in which another service user is directly participating in operation S632.

Before the end of broadcasting, an applicant that is selected as a cast member may be alternated in real time through the connection of the participation support system 300 and the content providing system 100. When alternation is determined, all service users that are registered as applicants may apply the appearance of broadcasting as cast members in all the stages of content, and may directly participate in broadcasting in real time in operation S634.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Internet Protocol Television (IPTV) remote participation broadcasting system for audience participation, comprising:
an IPTV participation support system obtaining an object picture of a broadcasting master and object pictures of a plurality of participation applicants, and combining the obtained object pictures in a content screen of a virtual environment to generate a real-time participation broadcasting picture in which the participation applicants participate directly; and
an IPTV head end system receiving the real-time participation broadcasting picture to transmit the real-time participation broadcasting picture, in which the broadcasting master and the participation applicants interact in the content screen of the virtual environment, to user terminals of the participation applicants over an IP communication network.

2. The IPTV remote participation broadcasting system of claim 1, wherein the IPTV head end system transmits live the real-time participation broadcasting picture to the user terminals.

3. The IPTV remote participation broadcasting system of claim 1, wherein the IPTV head end system transmits the real-time participation broadcasting picture in which the broadcasting master and the participation applicants interact in the content of the virtual environment through conversation, gesture and touch events.

4. The IPTV remote participation broadcasting system of claim 1, wherein the IPTV participation support system is connected to a content providing system which creates raw content for real-time participation content, and receives content of a virtual environment which is combined with the object pictures of the participation applicants and the object picture of the broadcasting master from the content providing system.

5. The IPTV remote participation broadcasting system of claim 1, wherein the IPTV participation support system receives entire pictures of the participation applicants which are obtained from the user terminals over the IP communication network, and extracts the object pictures of the participation applicants by using the received entire pictures.

6. The IPTV remote participation broadcasting system of claim 1, wherein the IPTV participation support system comprises:
a participant support server performing an operation which requests access to a participation broadcasting channel by the participation applicants and an operation of applying participation of corresponding participation applicants which desire to participate in the real-time participation broadcasting picture as a cast member;
a participation applicant selection module selecting the cast member from among the participation applicants;
an object picture extraction module extracting the object picture of the broadcasting master from an entire picture of the broadcasting master, and extracting the object pictures of the participation applicants from entire pictures of the participation applicants; and
a picture combination module combining the object picture of the broadcasting master, the object pictures of the participation applicants and the content screen of the virtual environment to generate the real-time participation content picture.

7. The IPTV remote participation broadcasting system of claim 6, wherein the participation applicant selection module receives a voice signal and the entire picture of the participation applicant, which are obtained through the terminals of the participation applicants over the IP communication network, and selects the cast member on the basis of a quality of the received entire picture and a quality of the received voice signal.

8. The IPTV remote participation broadcasting system of claim 6, further comprising a broadcasting station support server providing list information of the participation applicant which is transferred through the participant support server and the entire picture to a content providing system, for connecting with the content providing system comprising a broadcasting station.

9. The IPTV remote participation broadcasting system of claim 6, wherein the object picture extraction module receives the entire picture of the participation applicant from corresponding user terminals over the IP communication network, and receives the entire picture of the broadcasting master which is provided from the broadcasting station through the broadcasting station support server.

10. The IPTV remote participation broadcasting system of claim 6, wherein the picture combination module recognizes objects which exist in the object pictures of the participation applicants, recognizes conversation, touch and, gesture events which occur between the participation applicants in the virtual environment, and performs a corresponding event according to a predetermined interaction rule, when interaction between the participation applicants occurs.

11. The IPTV remote participation broadcasting system of claim 6, further comprising an IPTV participation support control server connected to the IPTV head end system,
wherein the IPTV participation support control server transmits guide information for a broadcasting participation service of the audience to a corresponding IPTV terminal through the IPTV head end system over the IP communication network.

12. The IPTV remote participation broadcasting system of claim 1, wherein each of the user terminals comprises an object picture extraction module extracting the object pictures of the participation applicants from entire pictures of the participation applicants, and transmits the extracted object pictures to the IPTV participation support system over the IP communication network.

13. A method for providing Internet Protocol Television (IPTV) remote participation broadcasting service for audience participation, comprising:
obtaining, by an IPTV participation support system, an object picture of a broadcasting master and object pictures of a plurality of participation applicants;
combining, by an IPTV participation support system, the obtained object pictures in a content screen of a predetermined virtual environment to generate a real-time participation broadcasting picture in which the participation applicants participate directly; and
transmitting live, by an IPTV head end system, the real-time participation broadcasting picture to user terminals of a plurality of IPTV audiences which comprise the participation applicants over an IP communication network.

14. The method of claim 13, wherein the generating of a real-time participation broadcasting picture comprises:
recognizing, by the IPTV participation support system, interaction between the participation applicants in the content screen of the virtual environment; and
performing, by the IPTV participation support system, a corresponding event in the content screen of the virtual environment according to a predetermined interaction rule.

15. The method of claim 14, wherein the recognizing of interaction comprises recognizing, by the IPTV participation support system, conversation, touch and gesture events which occur between the participation applicants in the content screen of the virtual environment.

16. A method for providing Internet Protocol Television (IPTV) remote participation broadcasting service for audience participation, comprising:
accessing, by a plurality of IPTV terminals, an IPTV participation education channel through an IPTV head end system;
registering, by the IPTV terminals, corresponding IPTV service users as participants of a participation broadcasting channel;
selecting, by an IPTV participation support system, at least one participant which desires to appear in broadcasting from among the registered participants;
combining, by the IPTV participation support system, the object picture of the broadcasting master and an object picture of the selected participant by using a content screen of a predetermined virtual environment as a background through a picture combination module to generate a real-time participation broadcasting picture; and
transmitting the real-time participation broadcasting picture to IPTV terminals of the participants through the IPTV head end system.

17. The method of claim 16, wherein the transmitting of the real-time participation broadcasting picture comprises transmitting live the real-time participation broadcasting picture to the IPTV terminals of the participants.

18. The method of claim 16, wherein the generating of a real-time participation broadcasting picture comprises:
receiving entire pictures of the participants from the IPTV terminals of the participants;
receiving an entire picture of the broadcasting master from a broadcasting station;
extracting, by an object picture extraction module comprised in the IPTV participation support system, the object pictures of the participants from the entire pictures of the participants, and extracting an object picture of a broadcasting teacher from an entire picture of the broadcasting master; and
combining the extracted object pictures of the participants and the object picture of the broadcasting teacher by using the content screen of the virtual environment which is created by the content provider as a background.

19. The method of claim 17, wherein the selecting of at least one participant comprises selecting a participant of a corresponding IPTV terminal, which transmit a high-quality picture among the entire pictures of the participants, as a cast member.

20. The method of claim 16, further comprising:
recognizing, by the IPTV participation support system, interaction between the participation applicants in the content screen of the virtual environment of, the real-time participation broadcasting picture; and
performing, by the IPTV participation support system, a corresponding event according to a predetermined interaction rule.
